(19) United States
(12) Patent Application Publication
(10) Pub. No.: US 2015/0260109 A1
(43) Pub. Date: Sep. 17, 2015

(54) ACTUATING UNIT FOR VARIABLE POWER PLANT COMPONENTS

(71) Applicant: FEV GmbH, Aachen (DE)

(72) Inventor: Karsten Wittek, Aachen (DE)

(21) Appl. No.: 14/418,472

(22) PCT Filed: Jul. 30, 2013
(86) PCT No.: PCT/EP2013/002256

§ 371 Date: May 15, 2015

(30) Foreign Application Priority Data
Jul. 30, 2012 (DE) 10 2012 014 918.2

(51) Int. Cl. F02D 15/02; F02B 75/24; F02B 75/04

(52) U.S. Cl. CPC F02D 15/02; F02B 75/045; F02B 75/047; F02B 75/044; F02B 75/243; F02D 2700/03

(57) ABSTRACT

The invention relates to a reciprocating-piston internal combustion engine with variable compression, having an actuating unit for changing a variable compression of the reciprocating-piston internal combustion engine, wherein, to change the variable compression, the actuating unit actuates a variable engine component of the reciprocating piston internal combustion engine in the form of a connecting rod with variable length, a piston with variable compression height and/or a crankshaft with variable crankshaft radius, and the actuating unit is arranged at a lower level than the reciprocating-piston internal combustion engine. Also proposed are a method and also an actuating unit for the same.

### CROSS-REFERENCE TO RELATED APPLICATIONS

This application is the U.S. national phase of PCT/EP2013/002256 filed Jul. 30, 2013, which claims priority of German Patent Application 10 2012 014 918.2 filed Jul. 30, 2012, the entire contents of which are incorporated herein by reference.

### FIELD OF THE INVENTION

The invention relates to a reciprocating-piston internal combustion engine with variable compression, having an actuating unit for changing a variable compression of the reciprocating-piston internal combustion engine, an actuating unit preferably for the proposed reciprocating-piston internal combustion engine, and a method for adapting a variable compression of a reciprocating-piston internal combustion engine, It is proposed to make it possible to use, herein, different variable engine components, namely
connecting rod of variable length,
piston with variable compression height,
crankshafts with variable crank radius.

These all are intended, inter alia, to realize a variable compression.

### BACKGROUND OF THE INVENTION

The variable engine components that Will be described in greater detail hereunder are different from an eccentrically adjustable crankshaft, as described e.g. in DE 100 08 423 A1, in that they are movable component parts of the drive, which, however, in themselves undergo an effective variation of length, The effective variations of length relate to the crank radius, the connecting rod length and the compression height, respectively. The eccentrically supported crankshaft, on the other hand, will effect a position change of the crankshaft as such, whereby the distance to the cylinder head, and thus the performed stroke, will change. In the sense of the present invention, however, there is not meant an eccentrically adjustable crankshaft when mention is made of a reciprocating-piston internal combustion engine with variable compression having an appertaining actuating unit. Instead, the actuating unit is exclusively suited to actuate the above mentioned engine components, but not to effect an eccentric adjustment of the crankshaft. In this invention, eccentrically adjustable crankshafts are excluded.

For variation of the kinematically effective lengths of the engine, namely connecting rod length, compression height or crank radius, there are known telescope-like elements as well as eccentric bearings. Partially, in some solutions, use is made of the operating principle “use of engine forces for adjustment”. In these cases, the forces prevailing at the eccentric support or at a telescopic element are used for adjustment. The adjustment to a desired position is desired, on the one hand, to be performed as fast as possible and, on the other hand, without damage and noteworthy development of noise. In experimental tests, it has become evident that an adjustment from one to another end position e.g. of an eccentric element in the small connecting rod eye, although it can be realized within a working cycle, involves the possibility of damage to the constructional parts when a mechanical end abutment is reached. As a consequence, the adjustment process shall be decelerated. Thus, the adjustment process will extend over several working cycles, which can also be referred to as a multi-cycle principle. This, in turn, entails the necessity of a device which will prevent an undesired resetting, e.g. by means of freewheeling, wherein the direction of the freewheeling can be switched. This switchable freewheeling can be realized by a hydraulic system. It is a common feature of known systems for realizing such a switchable hydraulic freewheeling that there exist two support chambers which can support the forces or moments and prevent an undesired resetting. These support chambers can be designed as reciprocating pistons or rotary pistons.

DE 10 2005 055 199 describes a length-variable connecting rod for realizing a variable compression, abbreviated VCR. Therein, the switching of the freewheeling direction is performed by alternately opening and respectively closing two support cylinders, wherein, for control of the exiting oil flow, a 3/2 way valve is used. Said 3/2 way valve is provided with a locking arrangement so that the respectively set switched position will be maintained as long as no actuation is performed. For transferring the 3/2 way valve into the respective other switching position, a mechanical actuating device will act on the valve, wherein this mechanical actuating device is connected to the cylinder crank housing. In the presented arrangement, this actuating device is installed below the cylinder tube and above the crankshaft.

This manner of actuation has the disadvantage of still necessitating relatively extensive modifications on an otherwise already existing engine, particularly on the cylinder crank housing.

It is an object of the present invention to make possible an actuation of variable engine components, wherein the actuation can be integrated in an engine with low expenditure for modification.

### SUMMARY OF THE INVENTION

The above object is achieved by a reciprocating-piston internal combustion engine with variable compression, by a first and a second reciprocating-piston internal combustion engine, by an actuating unit, and by a method. However, the features defined in the individual dependent claims are not restricted to the respective embodiments. Instead, one or a plurality of features from the main claim and the dependent claims can be rendered in more precise detail, or also substituted by, one or a plurality of features from the following description. Particularly, the present claims are to be considered only as a first effort to put the invention into words, however without intending to restrict the invention. Further, one or a plurality of features from different embodiments can be combined into further modifications.

There is proposed a reciprocating-piston internal combustion engine with variable compression, sometimes referred to as an VCR engine, comprising an actuating unit for changing a variable compression of the reciprocating-piston internal combustion engine, wherein, to change the variable compression, the actuating unit actuates a variable engine component in the form of a connecting rod with variable length, a piston with variable compression height and/or a crankshaft with variable crankshaft radius of the reciprocating-piston internal combustion engine, and the actuating unit is arranged at a lower level than the reciprocating-piston internal combustion engine. Particularly, the actuating unit can be arranged below a crankshaft of the engine. Thereby, for instance, the individual elements of the actuating unit can be combined into a pre-assembled module, so that the assembly process for the engine can be simplified.

According to a further embodiment of the reciprocating-piston internal combustion engine, it is provided that the actuating unit serves as an actuator of a hydraulic way valve of the variable engine component. it can also be provided that the actuating unit, in relation to a crankshaft, is arranged on a side facing away from a piston end face of the piston, preferably on a side of the crankshaft axis opposite to the piston end face. According to a further embodiment, it is provided that the reciprocating-piston internal combustion engine is a reciprocating-piston internal combustion engine designed according to the boxer principle wherein the actuating unit is arranged laterally below the reciprocating-piston internal combustion engine. Here, but also with other engine principles, it is preferred that the reciprocating-piston internal combustion engine comprises the actuating unit at a lateral position relative to a piston movement.

Besides, in the sense of the invention, an actuating unit is to be understood as a unit which preferably comprises one or a plurality of cam disks and a drive for displacing the cam disks. Also a movable follower element can belong to the actuating unit, by means of which a way valve, particularly of the hydraulic type, can be adjusted, As described above, the actuating unit serves for triggering an effective change of length in one of the variable engine components, preferably by influencing a hydraulic support of this variable engine component, as will still be explained in greater detail.

Preferably, the actuating unit can be actuated mechanically. Particularly, the mechanical actuation can be performed with the aid of cam disk elements. The cam disk elements can be connected to a push rod and are adapted to be guided particularly with the aid of guide rods. Thereby, a compact actuating unit for the VCR engine can be provided.

According to a preferred embodiment, actuation of at least one switching element is compulsory. For instance, an entire axial moving path of the switching element can be composed of a first portion which is compulsorily effected by a functional surface, and a second portion which is effected by a locking device. Thereby, it can be safeguarded that the VCR engine will work in failure-free manner when in operation.

Particularly, said at least one switching element has a moving path arranged in parallel to a longitudinal axis of a crankshaft of the engine. Thus, for instance, a moving path can describe a round arc around the crankshaft. This way, the engine can designed in a more compact manner so that the required constructional space for the engine can be reduced.

Preferably, at least one cam disk element and/or at least one cam disk unit are displaceable in parallel to the crankshaft.

According to a preferred embodiment, said at least one cam disk element and/or said at least one cam disk unit are adapted to be guided in the upper portion of an oil pan or in a bed plate.

Particularly, said at least one cam disk unit is designed as one part. For instance, the entire cam disk unit can be molded from only one piece of sheet metal, and the cam disk elements can be combined into a sole cam disk unit. Particularly, such a cam disk unit can comprise an articulating flap and a recess for path limitation. Thereby, manufacture of the cam disk unit can be simplified; it is not necessary to assemble the cam disk unit from a number of individual component parts. Further, a one-part cam disk unit makes it possible to simplify the construction of an actuating unit and thus of the entire engine.

Preferably, the at least one switching element has a nominal displacement in the range from 3 mm to 5 mm, particularly above 4 mm, and preferably a nominal displacement which is defined by a locking device. For instance, the nominal displacement can be equal to the total displacement of the switching element, and a total displacement of particularly 4 mm can be defined by the locking device. In this manner, it can be safeguarded that e.g. the cooperation between the cam disk unit and the switching element is adapted. The nominal displacement is defined to be that path which, out of a starting position, is covered e.g. by a pin as a switching element along an oblique surface formed like a ramp as a part e.g. of a cam disk. Thus, for instance, in the still to be described FIG. 11, there is shown a starting position as well as a switched position, wherein the switching element will be brought from the starting position into the other position by moving the actuating unit. If, for instance, a cam disk is slightly displaced due to a manufacturing tolerance or some other cause, there must be provided a tolerance reserve for the displacement of the switching element. The nominal displacement and a tolerance reserve which is provided due to deviations together will add up to a preferred total displacement of the switching element.

According to a preferred embodiment, a forced displacement corresponds to at least 50% of the nominal displacement of the switching element. Particularly, the forced displacement can at least be dimensioned to the effect that a ball of a locking mechanism can overcome the projection between the valleys of a locking contour. This can correspond e.g. to at least to half the total displacement of the switching element, wherein, in this case, the nominal displacement can correspond the total displacement. The forced displacement can be set to a higher value because it may happen that the switching element will not impinge on its nominal impingement point on a functional surface but beyond that point. This can be the case if, due to unavoidable tolerances, the cam disk unit is not in its nominal working position relative to the switching element. Thus, the forced displacement can correspond to at least half of the total displacement of the switching element plus an expected maximal cam disk tolerance reserve.

Preferably, the cam disk tolerance reserve is in the range from 0.5 mm to 1 mm. For instance, the cam disk tolerance reserve can be 1 mm. In correspondence thereto, the forced displacement could be e.g. 3 mm to allow for a total displacement of e.g. 4 mm. By such a provision, it can be safeguarded that the switching element can be “pushed over” at least beyond the maximum of the projection. The provided cam disk tolerance reserve can—but does not exclusively have to—be caused by the cam disk. Instead, various tolerances of various component parts and influences such as e.g. bearings, toothed wheels, expansion of material caused by changes of temperature, and wear, may together finally result in a deviation which will be handled by the cam disk tolerance.

Preferably, the oil-pan upper portion or the bed plate is centered with a crank housing in a form-locking manner, preferably by fastening means, particularly by screws, dowel pins, fitting sleeves or other form-locking elements. In this manner, it can be safeguarded that the function of the actuating unit and thus of the engine are not impaired, e.g. due to an accumulation of tolerances such as axial play between connecting rod and crankshaft, and/or axial play between crankshaft and axial support.

Further proposed are a first reciprocating-piston internal combustion engine and a second reciprocating-piston internal combustion engine, wherein the first reciprocating-piston internal combustion engine and the second reciprocating-piston internal combustion engine are different from each other substantially only by a VCR actuating unit as described above and hereunder, so that one of the two reciprocating-piston internal combustion engines has a variable compression and the other one does not. According to one embodiment, even the connecting rods can be substantially identical. For instance, it is possible to use the same type of connecting rod, namely one with and a further one without hydraulic adjustment.

For the following explanations, it is assumed that the variable engine component, e.g. a VCR connecting rod according to DE 10 2005 055 199, comprises a hydraulic way valve which has at least 2 switching positions. In a patent application of the applicant, FEV GmbH, having the same application date of Jul. 30, 2012 and bearing the file number DE 10 2012 014 916, entitled “Hydraulischer Freilauf für variable Triebwerksteile”, and in its related subsequent application DE 10 2012 020 999, various possibilities for interconnection are described. Further, on the variable engine component, a receiving device is arranged which can receive an actuation signal and then, according to a specific regularity, will move the way valve to a specific switching position. In this regard, a monostable as well as a bistable configuration are possible. Full reference is made herewith to the relevant contents of said applications within the framework of the disclosure of said applications.

Thus, an engine manufacturer can realize a VCR engine variant from an engine without VCR, wherein the construction of the engine without VCR can be designed largely without giving consideration to the VCR variant.

According to a further idea of the invention which can be realized alone or also in combination with one or a plurality of other ideas of the invention, there is proposed an actuating unit for changing a variable compression of a reciprocating-piston internal combustion engine in the form of a prefabricated module. The actuating unit is used with preference in a reciprocating-piston internal combustion engine as described above and hereunder in greater detail.

Preferably, the actuating unit comprises a number of cam disks corresponding to a number of cylinders, said cam disks being rigidly connected to each other, wherein a drive is provided which engages the actuating unit and by means of which the cam disks will be moved simultaneously for effecting a change of a variable compression of a reciprocating-piston internal combustion engine.

A further idea of the invention which again can be realized alone or also in combination with one or a plurality of other ideas of the invention, relates to a method for adapting a variable compression of a reciprocating-piston internal combustion engine, preferably a reciprocating-piston internal combustion engine as described above and hereunder in greater detail, wherein an actuating unit is operative to act on a variable engine component from the group comprising a connecting rod with variable length, a piston with variable compression height and a camshaft with variable crank radius, wherein an adjustment of the variable engine component is performed by use of a hydraulic arrangement, which will lead to a change of the variable compression. Preferably, in this regard, an adjustment is effected via at least one cam disk of the actuating unit. The cam disk is designed as described above and hereunder in greater detail.

Further advantageous embodiments and modifications are evident from the Figures mentioned hereunder. However, the features evident from the Figures are not restricted to the individual embodiment. Instead, one or a plurality of features from one or a plurality of embodiments can be combined among each other or also with features from the above general description so as to obtain further embodiments of the invention. Thus, the following embodiments serve for illustration of the various possibilities and aspects of the invention without, however, restricting the invention to these embodiments.

### BRIEF DESCRIPTION OF THE DRAWINGS

In the Figures, the following is illustrated:

FIG. 1 shows a first exemplary embodiment of an actuating unit,

Fig. 2 shows an exemplary hydraulic way valve which can be used e.g. together with the actuating unit of FIG. 1,

FIG. 3 shows a first cam disk element and a second cam disk element of an actuating unit, with the cam disk elements being connected to a push rod,

FIG. 4 illustrates, in lateral view, a cooperation between a switching element and a “reverse movement” functional surface and an “advance movement” functional surface of an actuating unit,

FIG. 5 illustrates a cooperation between an actuator motor and a cam disk element of an actuating unit,

FIG. 6 shows an exemplary cylinder crank housing having an oil-pan upper portion and an actuating unit,

FIG. 7 shows a connection plate connected to a cam disk element,

FIG. 8 shows a cam disk unit having an oil-pan upper portion, with an articulating shaft being arranged on the oil-pan upper portion,

FIG. 9 shows an oil-pan upper portion with an actuator motor for adjusting the actuating unit,

FIG. 10 shows an actuator motor with an articulating eccentric element,

FIG. 11 illustrates a cooperation between a switching element and an “advance movement” functional surface of an actuating unit, and

FIG. 12 illustrates a first state of an exemplary switching element, wherein the switching element is leaving a functional surface of the actuating unit.

### DETAILED DESCRIPTION OF THE INVENTION

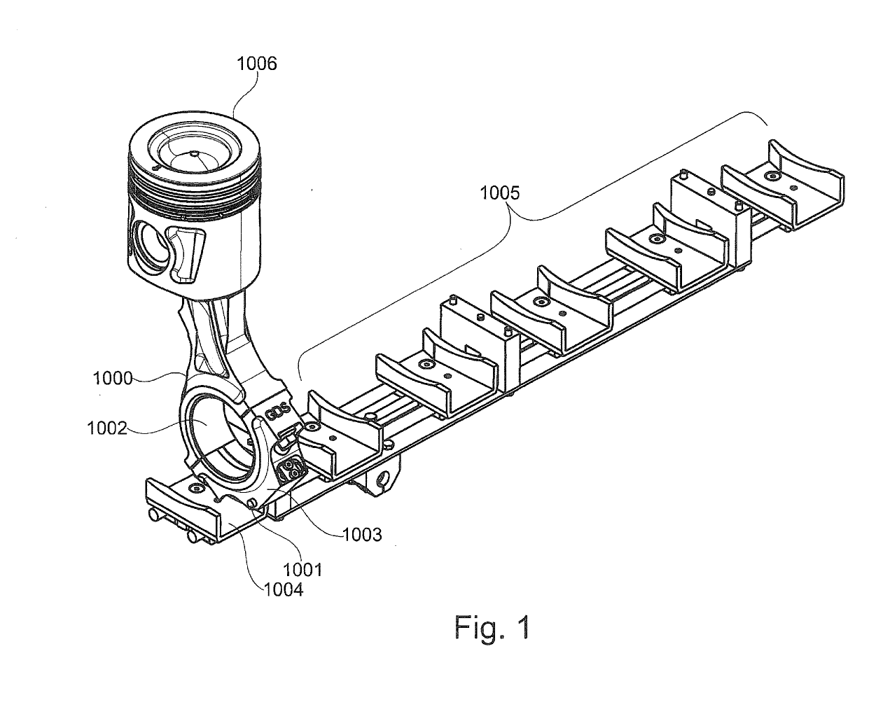

FIG. 1 shows a connecting rod 1000 wherein a switching element 1001 is arranged on the large connecting-rod eye 1002. An adjustment device for adjusting a compression ratio that can be varied by setting, is arranged on the small connecting-rod eye of connecting rod 1000. In FIG. 1, this adjustment device is hidden from view by a piston 1006. Particularly, the switching element 1001 can be integrated into the connecting-rod cap 1003. Further, a cam disk element 1004 for operating the switching element 1001 can be arranged below the crankshaft of the reciprocating-piston internal combustion engine. Particularly, for each connecting rod of a cylinder of the reciprocating-piston internal combustion engine, there is provided a respective cam disk element. The individual cam disk elements of the respective cylinders are preferably combined into a prefabricated module 1005. The module 1005 shown in FIG. 1 is provided for a 6-cylinder in-line engine.

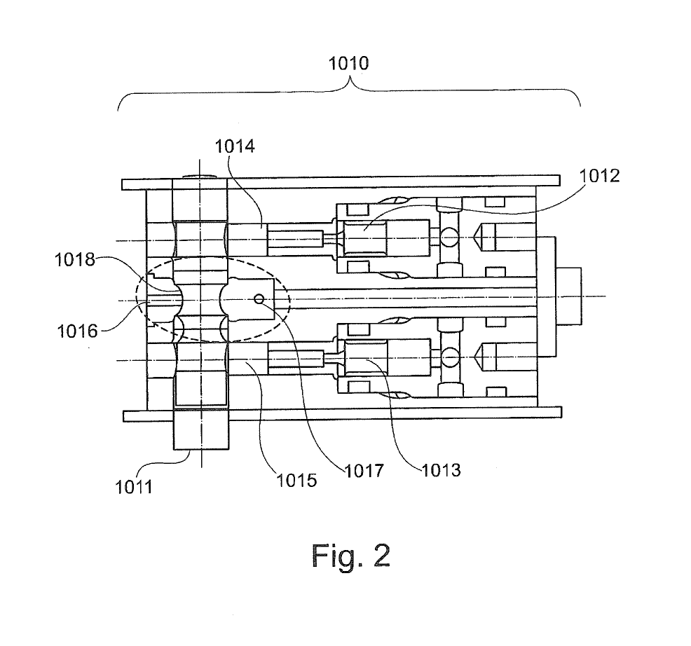

FIG. 2 shows a hydraulic way valve 1010 for hydraulic control of a working chamber of the type illustrated e.g. in FIG. 1 of DE10 2005 055 199 as working chamber 29.1 and 29.2, respectively. Particularly, the hydraulic way valve 1010 is operative to clear a drain bore respectively assigned to a working chamber. Such a drain bore is shown e.g. in FIG. 2 thereof as drain bore 36. Said hydraulic way valve 1010 has at least 2 switching positions. In the above mentioned patent application of the applicant, FEV GmbH, having the same application date of Jul. 30, 2012, entitled “Hydraulischer Freilauf für variable Triebwerksteile” and bearing the file number DE 10 2012 014 916, and its related subsequent application DE 10 2012 020 999, various possibilities for interconnection in a hydraulic way valve are described. With respect to a possible arrangement of the hydraulic circuit in the connecting rod and the design of the circuit in the connecting rod, reference is made herewith to the full contents of said applications within the framework of the disclosure of said applications. According to a special embodiment, the way valve 1010 is controlled via the switching element 1011. Thus, by movement of the switching element 1011, the way valve 1010 can be moved into a specific switching position. In this regard, both a monostable and a bistable configuration are possible.

Further, FIG. 2 shows a design of a hydraulic way valve as a 3/2 way valve comprising a switching element 1011 which particularly can be integrated in the connecting-rod support cap 1003. Herein, the 3/2 way function is realized by the cooperation of a first 2/2 way valve 1012 and a second 2/2 way valve 1013. The 2/2 way valves 1012 and 1013 can be designed as seat valves, e.g. as a ball-type back-check valve which can be pushed open by a plunger. A first plunger 2014 is assigned to the first 2/2 way valve 1012. Further, a second plunger 2015 is assigned to the second 2/2 way valve 1013. By means of a locking device 2016, the switching element can be maintained in a specific switching position. Said locking device 2016 can be realized by a resilient pressure member 1017 and by a locking contour 1018 formed on the switching element 1011. For preventing that the 2/2 way valves will be opened unintentionally by the plungers under the influence of inertia forces, the plungers are pressed against the switching element 1011 by springs.

According to a special embodiment, operation of the hydraulic way valve 1010 is provided in a mechanical manner. According to a further embodiment, operation of the hydraulic way valve 1010 is provided in a hydraulic manner through oil pressure variation. According to an embodiment differing therefrom, operation of the hydraulic way valve 1010 is provided with the aid of an oil jet. In this case, there is particularly performed a pulse exchange between the oil jet and the hydraulic way valve 1010. According to a further embodiment, operation of the hydraulic way valve 1010 is provided by variation of a magnetic field arranged near the hydraulic way valve 1010.

In an embodiment wherein operation of the hydraulic way valve 1010 is provided in a hydraulic manner, said hydraulic way valve 1010 is preferably connected to a hydraulic cylinder. A stroke of the hydraulic cylinder will preferably act on the hydraulic way valve 1010. This hydraulic cylinder will hereunder be referred to as a hydraulic switch because it influences the switching position of the way valve. In the most simple case, the hydraulic switch consists of a piston acting against a spring force. One effective surface of this piston is connected to a pressure oil conduit which in turn is connected to the lubricating system of the engine. By variation of the oil pressure, the position of the switch can be influenced. Increase of pressure will cause the spring to be compressed, and pressure relief will cause the spring to relax again. Thus, the switch has a rnonostable way of operation, in analogy to a push button. For making it possible to permanently maintain a specific switch state, also the oil pressure has to be permanently increased and decreased, respectively, i.e. the oil pressure has to be statically varied.

In a two-staged operational mode of a variable engine component, such as e.g. a connecting rod with variable effective length, the switch can be designed in the following manner: According to a first embodiment, a valve is subjected to a low pressure. In this case, there exists a freewheeling direction of the eccentric element toward a low compression ratio. According to a second embodiment, a freewheeling direction of the eccentric element toward of a high compression ratio can be effected.

Under the assumption that the pressure oil conduit is connected to the connecting rod bearing, it is required for operation that the supply oil pressure at the main bearing—and thus the pressure at the outlet of the oil pump—will be varied. The engine is normally desired to be operated with low compression only in operational states of high loads. The second variant has the advantage that, in case of high loads, the engine has to be operated with increased oil pressure. The thus entailed higher oil pump drive power will in case of high loads lead to a mere slight increase of the total engine friction and is to be preferred under the aspect of efficiency.

A further embodiment comprises a hydraulic dynamic switch. The hydraulic dynamic switch is designed to allow for a bistable operational mode. For changing a switch position, the oil pressure has to be increased or decreased only briefly. Preferably, the switch is adapted to react on brief increases of pressure. in case of faulty switching, however, it may happen that the switch will not be switched. Thus, not all of the cylinders of an engine have the same switch position. This problem can be alleviated by adding a “reset function” to the described switch. According to this function, it is provided that, when the oil pressure falls below a threshold value, the switch will automatically assume a preset switch position, irrespective of the previously assumed switch position. Thus, deviations from the switching position caused by faulty switching can be alleviated in a simple manner by briefly switching off the engine.

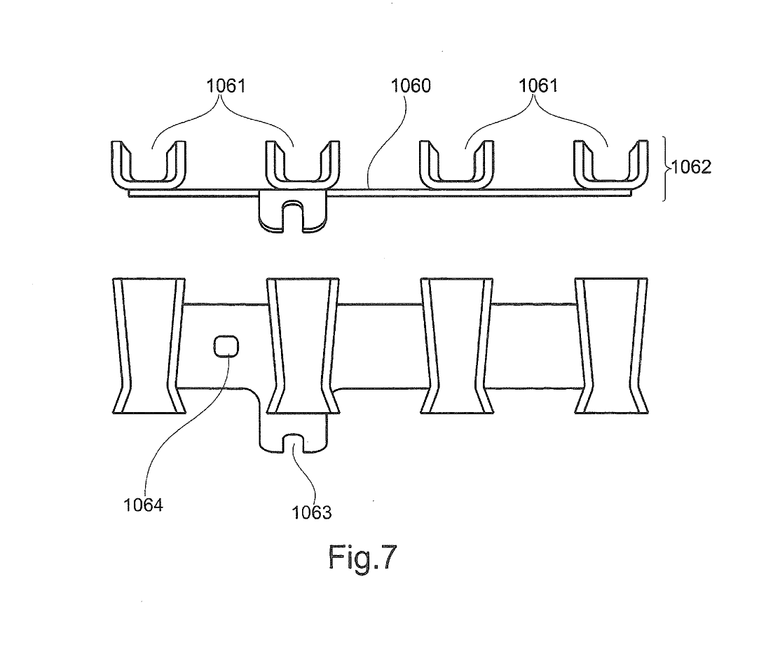

Hereunder, there will be described primarily an embodiment wherein the operation of the switching element 1011 is performed mechanically. Particularly, the mechanical operation is performed with the aid of cam disk elements as shown in FIG. 7.

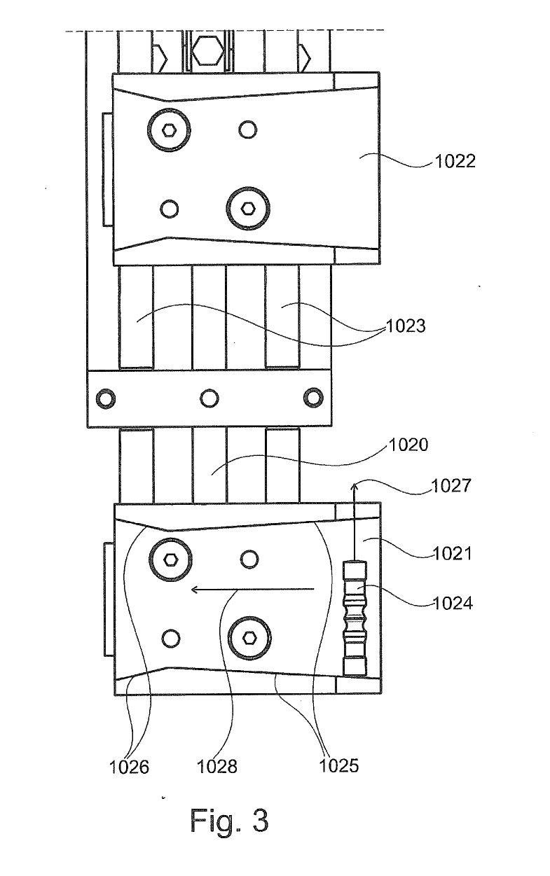

FIG. 3 shows a first cam disk element 1021 and a second cam disk element 1022 which are connected to each other by a push rod 1020. The cam disk elements 1021 and 1022 are particularly guided with the aid of two guide rods 1023. Each cam disk element preferably comprises two “advance movement” functional surfaces 1025 and two “reverse movement” functional surfaces 1026. The end face of switching element 1024 can be axially displaced particularly by the “advance movement” functional surfaces 1025. An exemplary axial displacement of switching element 1024 is marked by the arrow 1027. In case of an axial displacement 1027 of switching element 1024, the switching element 1024 will preferably undergo, relative to cam disk element 1021, at least one longitudinal displacement 1028. In order to prevent a shearing deviation of switching element 1024 during reverse rotation of the crankshaft, the switching element 1021 comprises the “reverse movement” functional surfaces 1026. This surface can be designed in a steeper orientation because only low path speeds are to be expected.

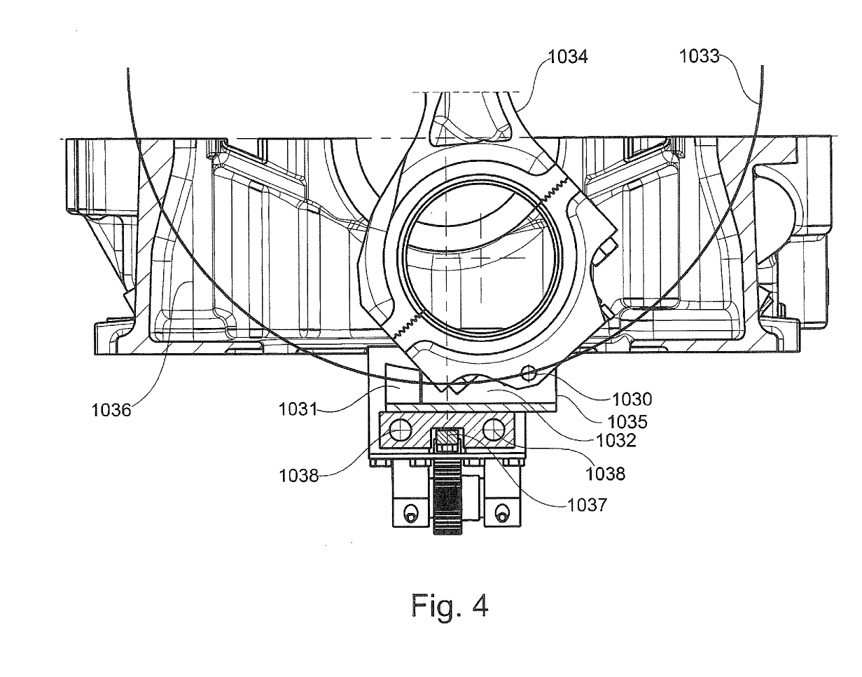

FIG. 4 illustrates, in lateral view, the cooperation between a switching element 1030 and a “return movement” functional surface 1031 and an “advance movement” functional surfaces 1032. The middle axis of switching element 1030 describes a moving path 1033 whose shape is dependent on the position of the switching element on a connecting rod 1034 and on the drive system geometry. A cam disk element 1035 will be axially displaced by a specific amount relative to the bed plate 1036 so as to assume the respective working positions. The moving path is e.g. about 4 mm. During the movement of cam disk element 1035, the latter is guided with the aid of the guide rods 1038. The push rod 1037 has a toothed rack fixedly connected to it.

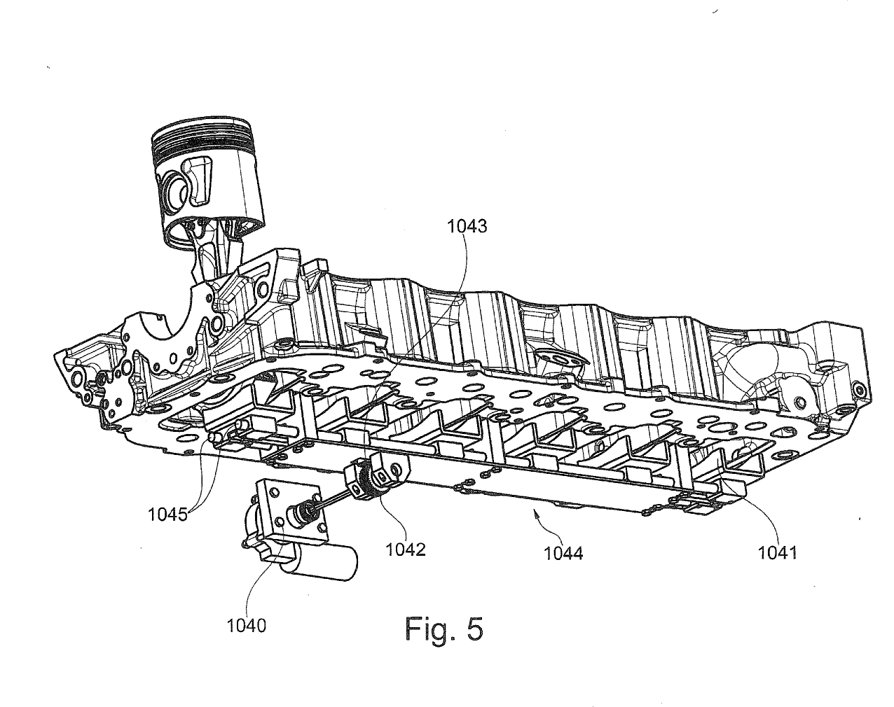

FIG. 5 illustrates the cooperation between an actuator motor 1040 and a cam disk element 1041. The cam disk element 1041 is driven by actuator motor 1040 by means of a pinion 1042 via a toothed rack 1043. Actuator motor 1040 can be e.g. an electric 12-V-motor with reduction gear. A pre-mounted actuating unit 1044 which comprises at least the cam disk element 1041, the pinion 1042 and the toothed rack 1043, can be screwed from below against a bed plate of the reciprocating-piston internal combustion engine. FIG. 5 further shows guide rods 1045 for guiding the cam disk elements during the movement of the cam disk elements.

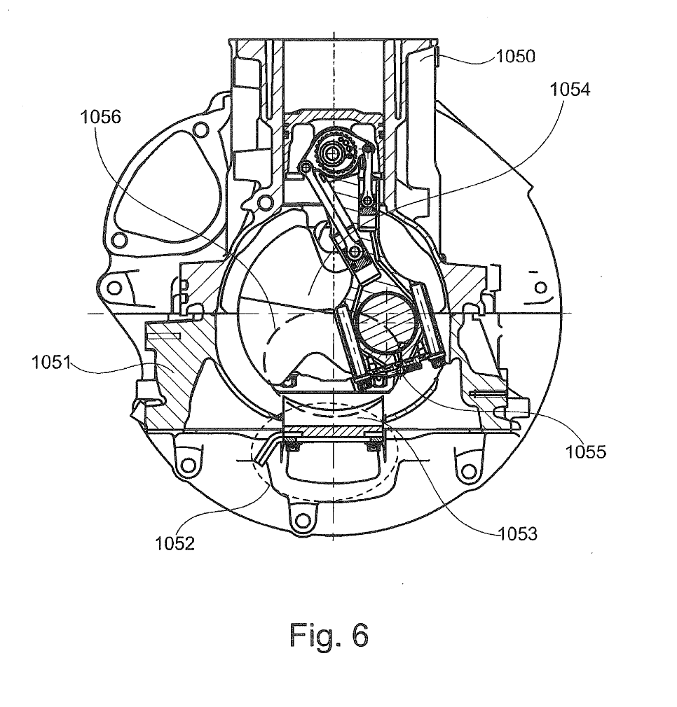

FIG. 6 shows a cylinder crank housing 1050 with an oil-pan upper portion 1051 and an actuating unit 1052. The actuating unit 1052 comprises at least one cam disk element 1053. In this embodiment, the mechanical actuating unit 1052 is integrated in the oil-pan upper portion 1051. The cylinder crank housing 1050 is preferably realized in the “short skirt” design with individual bearing flaps. Preferably, for stiffening the overall structure, a correspondingly stiff oil-pan upper portion 1051 is screwed from below against the cylinder crank housing 1050. When the crankshaft 1054 performs a full rotation, this will result in a moving path 1056 for the middle axis of switching element 1055.

FIG. 7 shows cam disk elements 1061 connected to a connection plate 1060. The individual cam disk elements 1061 are fixedly connected to the connection plate 1060, preferably by being welded, soldered or bolted. The connection plate 1060 as well as the individual cam disk elements 1061 can be produced in an inexpensive manner as a punched-out bent sheet metal piece. There would also be possible a construction wherein the complete cam disk unit 1062 is formed of only one sheet metal piece and the cam disk elements 1061 are combined into a sole cam disk unit 1062. Particularly, such a cam disk unit 1062 comprises an articulating flap 1063 and a recess 1064 for path delimitation.

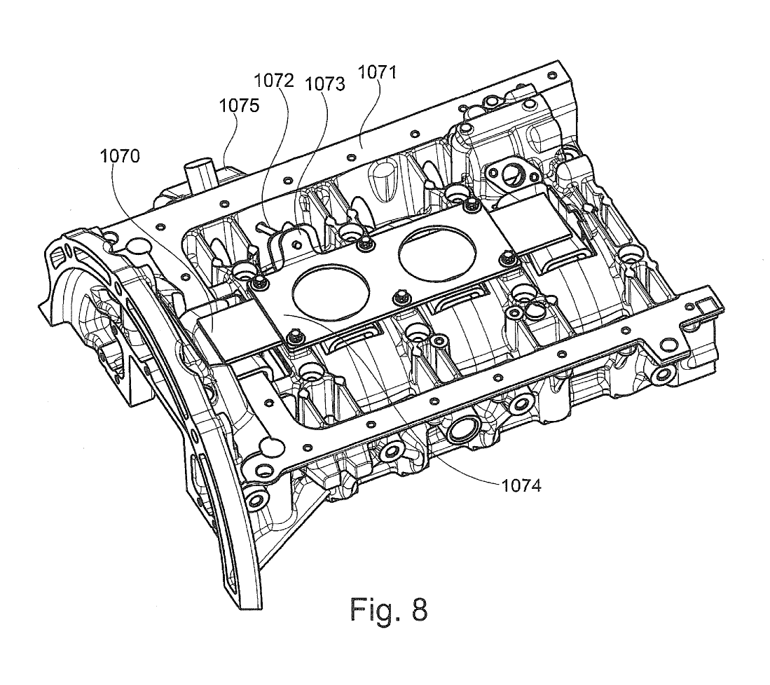

FIG. 8 shows a cam disk unit 1070 with an oil-pan upper portion 1071. On said oil-pan upper portion 1071, an articulating shaft 1072 is arranged. The cam disk unit 1070 is preferably guided in the oil-pan upper portion 1071. For this purpose, the oil-pan upper portion 1071 comprises corresponding guiding surfaces in the area of the transverse bulkhead. A holding plate 1074 is effective to prevent the arrangement from falling out from a guiding surface. Said holding plate 1074 can be realized as a simple punched-out bent sheet metal piece and is screwed from below against the oil-pan upper portion 1071. Said holding plate further comprises a flap 1073 for support of the articulating shaft 1072. Further, an actuator motor 1075 is arranged on the oil-pan upper portion 1071.

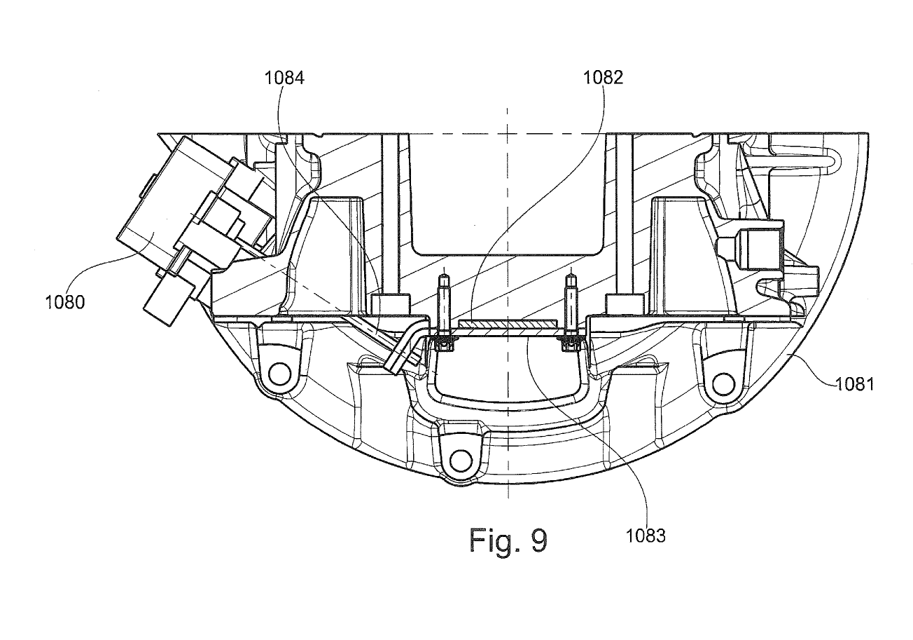

FIG. 9 shows, in lateral view, an oil-pan upper portion 1081 with an actuator motor 1080, a connection plate 1082 of cam disk unit 1070 and a holding plate 1083. Said cam disk unit 1070 is driven by the electric actuator motor 1080 and an articulating shaft 1084 connected to actuator motor 1080. The actuator motor 1080 is preferably screwed laterally to the oil-pan upper portion 1081.

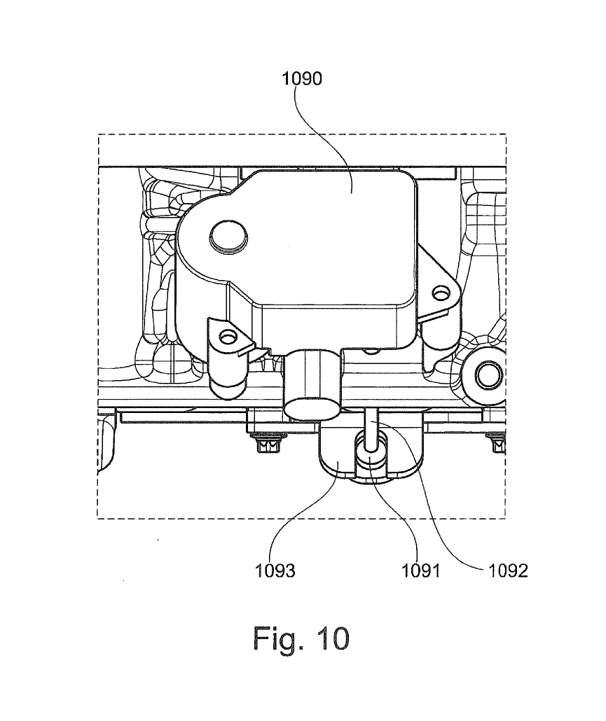

FIG. 10 shows an actuator motor 1090 with an articulating eccentric element 1091. Said cam disk unit 1070 is driven by the electric actuator motor 1090. Said articulating eccentric element 1091 is formed at the end of the articulating shaft 1092 or is connected as a separate part to articulating shaft 1092. Said articulating eccentric element 1091 engages an articulating flap 1093 of cam disk unit 1070 and will convert the rotary movement of articulating shaft 1092 to a translatory movement of cam disk unit 1070.

As an alternative to articulation by means of an eccentric element, conversion of the rotary movement to a translatory movement could also be realized by means of a pinion and a toothed rack. A further possibility of driving the cam disk unit could reside in an end-side drive by means of a linear actuator. For driving, electric motors are suited, preferably those having a reduction gear, which are installed also at other sites on the reciprocating-piston internal combustion engine, e.g. as actuators for waste gate flaps on exhaust gas turbochargers, tumble valves and/or exhaust gas return valves.

As an alternative to an electric motor, the stroke movement could also be generated directly with the aid of a magnetic actuator, e.g. by means of an actuator which, in a similar form, is used in electromagnetic valve drives. The magnetic actuator would have the advantage of very fast actuation. Thus, it would be possible to fully displace the cam disk unit within one revolution of the engine or still faster.

A further possibility for driving the cam disk unit could reside in the use of a hydraulic or pneumatic actuator, preferably a hydraulic or pneumatic linear cylinder. In case of the hydraulic drive, the required pressure could be generated by the motor oil pump. In case of the pneumatic drive, use could be made of the suction tube vacuum. The latter, however, would be available only in the range of the partial load. If one would connect the pneumatic cylinder to a vacuum pump, the pneumatic energy would be available nearly independently from the engine load. As a further possibility, the charging pressure could be used for operation.

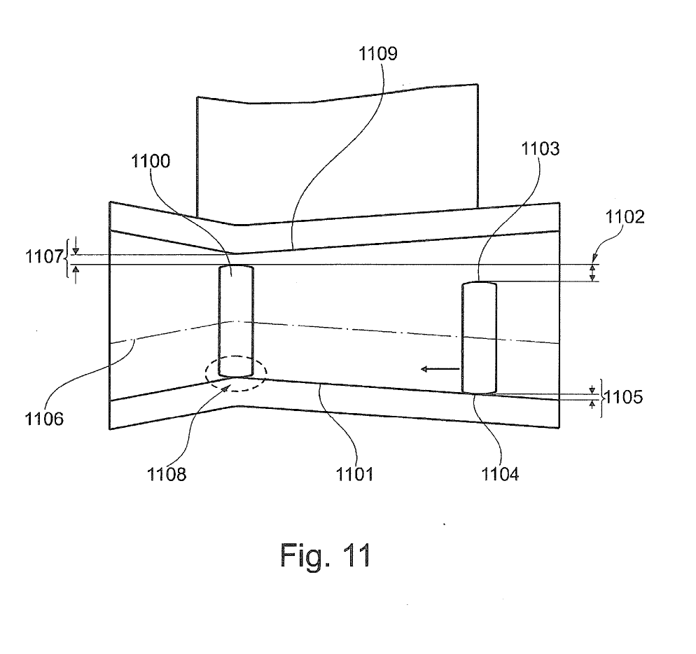

FIG. 11 illustrates a cooperation between a switching element 1100 and an “advance movement” functional surface 1101. The cam disk unit should comprise a moving path that fits to the axial moving path of the switching element which is to be actuated. The total axial moving path is composed of a first portion which is enforced by the functional surface 1101, and a second portion which is provided by the locking device 1016. In FIG. 11, there is outlined the path of the center 1106 of switching element 1100. The forced displacement 1102 should at least be dimensioned large enough so that a ball of a locking mechanism as shown e.g. in FIG. 2 as locking mechanism 1016, will overcome the projection between the valleys of a locking contour as shown e.g. in FIG. 2 as locking contour 1018. Thus, this corresponds to at least half of the total displacement of switching element 1100. It is safer to give the forced displacement 1102 a larger dimension since it may happen that the switching element does not impinge onto the functional surface on the nominal impingement point 1104 but beyond the same. This will occur e.g. if, due to unavoidable tolerances, the cam disk unit is not in its nominal working position relative to the switching element. Therefore, the forced displacement should correspond at least to half of the total displacement of switching element 1100 plus an expected maximal cam-disk tolerance reserve 1105. Thus, the forced displacement 1102 as a nominal displacement and the tolerance reserve provided due to deviations will together result in a preferred total displacement of switching element 1100.

According to an exemplary embodiment, a total displacement of 4 mm of switching element 1100 can be predefined by the locking device 1016. In this case, a cam-disk tolerance reserve 1005 of 1 mm can be provided. In correspondence thereto, the forced displacement 1102 should be at least 3 mm. By such an arrangement, it is safeguarded that the switching element has been “pushed over” at least beyond the maximum of the projection. The rest of the path, having a length of 1 mm, will be covered with the aid of the spring-biased ball.

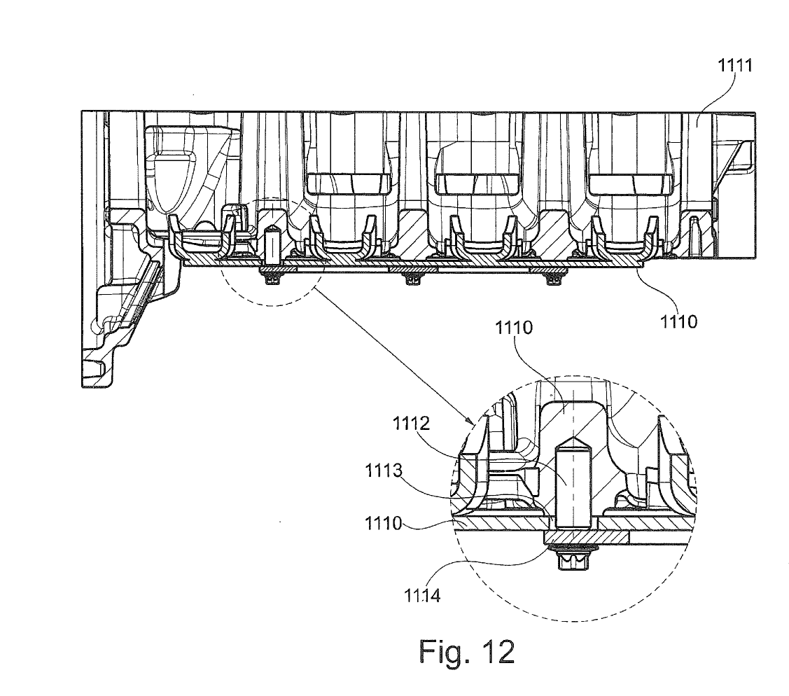

In FIG. 12, there is shown a first state of switching element 1100 wherein the switching element 1100 is just leaving the functional surface 1101, With the next revolution of the crankshaft, the switching element will have arrived at its end position. Thus, in this exemplary embodiment, a free distance of 1 mm will have opened up between the top portion 1103 of switching element 1100 and the functional surface 1101. The distance 1107, marked in FIG. 12, between the top portion 1103 of switching element 1100 and the upper functional surface 1109 should be dimensioned to the effect that, in the final state, the same distance 1107 will exist on both sides. In this exemplary embodiment, this will be a value of 2 mm. Thus, the required moving path of the cam disk unit has to correspond to the total displacement of the switching element 1100. For the case that the switching element should impinge on the functional surface before the nominal impingement point 1104, the functional surface is extended “rearwards”, notably so far that, in the most unfavorable case, the top portion 1103 will still impinge on the edge.

In order to have to provide merely a smallest possible cam-disk tolerance reserve 1105, the cam disk unit 1070 should be adjusted relative to the connecting rod as precisely as possible. For instance, a crank-end guidance of the connecting rod can be realized. According to another arrangement, also a piston-end guidance of the connecting rod can be realized, For precise adjustment of the connecting rod relative to the cam disk unit, particularly a crank-end guidance of the connecting rod is provided, Nonetheless, there still remains a relatively long tolerance chain which influences a minimal required cam-disk tolerance reserve 1005. Such a tolerance includes particularly the axial play of the connecting rod relative to the crankshaft, the axial play of the crankshaft relative to the axial support which can be arranged either in the upper or the lower part of the crank housing, and the play resulting from the mounting position of the on-pan upper portion relative to the crank housing. Preferably, the oil-pan upper portion is connected to the crank housing by pinning.

FIG. 12 is an enlarged partial view of a connection between a cam disk unit 1110 and an oil-pan upper portion 1111. The path of cam disk unit 1110 should be provided with a path limitation relative to the oil-pan upper portion 1111, preferably realized by an abutment pin 1112 and a corresponding recess 1113 in the cam disk unit 1110. FIG. 12 further shows a holding plate 1114 as also shown in FIG. 9 as holding plate 1074.

1. A reciprocating-piston internal combustion engine with variable compression, comprising:
an actuating unit that changes a variable compression of the reciprocating-piston internal combustion engine,
to change the variable compression, the actuating unit actuates a variable engine component in the form of a connecting rod with variable length, a piston with variable compression height or a crankshaft with variable crankshaft radius of the reciprocating-piston internal combustion engine, and
the actuating unit is arranged at a lower level than the reciprocating-piston internal combustion engine.

2. The reciprocating-piston internal combustion engine according to claim 1, wherein the actuating unit serves as an actuator of a hydraulic way valve of the variable engine component.

3. The reciprocating-piston internal combustion engine according to claim 1, wherein the actuating unit, in relation to a crankshaft, is arranged on a side facing away from a piston end face of the piston, preferably on a side of the crankshaft axis opposite to the piston end face.

4. The reciprocating-piston internal combustion engine according to claim 3, wherein the reciprocating-piston internal combustion engine is a reciprocating-piston internal combustion engine designed according to the boxer principle, and the actuating unit is arranged laterally below the reciprocating-piston internal combustion engine.

5. The reciprocating-piston internal combustion engine according to claim 1, wherein the reciprocating-piston internal combustion engine includes the actuating unit at a lateral position relative to a piston movement.

6. The reciprocating-piston internal combustion engine according to claim 1, wherein the actuating unit can be actuated mechanically.

7. The reciprocating-piston internal combustion engine according to claim 1, wherein the actuation of at least one switching element acts on a hydraulic way valve so as to effect a change of the variable compression.

8. The reciprocating-piston internal combustion engine according to claim 7, wherein the at least one switching element includes at least one moving path arranged parallel to a crankshaft of the engine.

9. The reciprocating-piston internal combustion engine according to claim 1, wherein the actuating unit includes at least one cam disk element or at least one cam disk unit which is displaceable parallel to the crankshaft.

10. The reciprocating-piston internal combustion engine according to claim 9, wherein the at least one cam disk element or the at least one cam disk unit are arranged in an oil-pan upper portion or in a bed plate and are adjustable therein.

11. The reciprocating-piston internal combustion engine according to claim 9, wherein the at least one cam disk unit is designed as one part.

12. The reciprocating-piston internal combustion engine according to claim 7, wherein the at least one switching element has a nominal displacement in the range from 3 mm to 5 mm, particularly above 4 mm, and preferably a nominal displacement which is defined by a locking device.

13. The reciprocating-piston internal combustion engine according to claim 12, wherein a forced displacement corresponds to at least 50% of the nominal displacement of the switching element.

14. The reciprocating-piston internal combustion engine according to claim 12, wherein a cam disk tolerance reserve is in the range from 0.5 mm to 1 mm.

15. The reciprocating-piston internal combustion engine according to claim 10, wherein the oil-pan upper portion or the bed plate is centered with a crank housing in a form-locking manner, preferably by fastening means, particularly by screws, dowel pins, fitting sleeves or other form-locking elements.

16. A first reciprocating-piston internal combustion engine and a second reciprocating-piston internal combustion engine, wherein the first reciprocating-piston internal combustion engine and the second reciprocating-piston internal combustion engine are different from each other substantially only by an actuating unit according to claim 10 so that one of the two reciprocating-piston internal combustion engines has a variable compression and the other one does not.

17. An actuating unit for changing a variable compression of a reciprocating-piston internal combustion engine, provided as a prefabricated module for a reciprocating-piston internal combustion engine according to claim 1.

18. The actuating unit according to claim 17, wherein the actuating unit comprises a number of cam disks corresponding to a number of cylinders, said cam disks being rigidly connected to each other, wherein a drive is provided which engages the actuating unit and by means of which the cam disks are moved simultaneously for effecting a change of a variable compression of a reciprocating-piston internal combustion engine.

19. A method for adapting a variable compression of a reciprocating-piston internal combustion engine, preferably a reciprocating-piston internal combustion engine according to claim 1, wherein an actuating unit is operative to act on a variable engine component from the group comprising a connecting rod with variable length, a piston with variable compression height and a camshaft with variable crank radius, wherein an adjustment of the variable engine component is performed by use of a hydraulic arrangement, whereby a change of the variable compression is effected.
